(19) United States
(12) Patent Application Publication
(10) Pub. No.: US 2010/0213868 A1
(43) Pub. Date: Aug. 26, 2010

(54) VEHICLE MULTIFUNCTIONAL LAMP

(76) Inventor: Yung-Fa Lin, Taipei County (TW)

Correspondence Address: RABIN & Berdo, PC, 1101 14TH STREET, NW, SUITE 500, WASHINGTON, DC, 20005, US

(21) Appl. No.: 12/389,599

(22) Filed: Feb. 20, 2009

(51) Int. Cl. H05B 37/02; B60Q 1/00; B60Q 1/26

(52) U.S. Cl. 315/294; 362/459; 362/487

(57) ABSTRACT

A vehicle multifunctional lamp is provided. The vehicle multifunctional lamp mainly includes a lamp body, a lamp shade, and light source sets. The light source sets have at least two sets. In the at least two light source sets, at least one set is daylight lamps, and the rest is one or more of others such as sidelights, fog lamps, or turn signal lamps. Therefore, the lamp formed of the same lamp body and the lamp shade has car indicators having more than two functions. Thereby, the present invention is convenient to install.

### BACKGROUND OF THE INVENTION

1. Field of Invention

The present invention relates to a vehicle multifunctional lamp, and more particularly, to a daylight lamp structure for use in a vehicle and having functions of other indicators. When an auxiliary lamp for daylight use only is installed on a car according to regulations or security factors, it is not necessary to find or establish a position to dispose the lamp. Instead, installment positions of sidelights, fog lamps or turn signal lamps originally equipped for a car may be directly selected for replacement, so as to achieve an effect of easy installment, time-saving, and labor-saving.

2. Related Art

For vehicles in use at present such as various types of cars, RVs, buses, or other vehicles, a plurality of indicators besides lighting lamps are disposed on the front or/and back of a car. These statutory indicators (such as turn signal lamps, sidelights, or even brake lights in the backside) have covered all positions on the front side or back side of a car where a lamp may be installed. However, currently, some regions or countries further explicitly stated that cars should also turn on daylight lamps during daylight (vehicle indicators for use in daylight only, the brightness of which is stronger than normal indicators, but weaker than the lighting lamps) to show that the vehicles are on the move. And it is specified that the daylight lamps should be installed at specific regional positions close to two sides of the vehicle. Thus, in addition to various indicators equipped on the vehicle, a set of daylight lamps needs to be added, which is actually difficult. Especially for minivans, when a set of daylight lamps needs to be further installed in addition to its exquisite vehicle shape, it is difficult to open a mounting hole. It would be abrupt if the daylight lamps are exposed. Therefore, further development and improvement are still necessary and desired.

The existing two types of conventional vehicle lamps make it quite difficult and inconvenient to further install a set of daylight lamps on the front or/and back of the car. In view of this defect, it is considered that the conventional structure has the room and necessity for improvement. A brand new vehicle multifunctional lamp is finally designed after careful researches in connection with the inventor's many years' experience of designing and manufacturing in this field.

A major objective of the present invention is to provide a vehicle multifunctional lamp. The vehicle multifunctional lamp may conform to regulations and demands for safe driving. Also, the lamp has a daylight lamp structure for easy installment, such that effects of simplified mechanism, convenient assembly, and decreased cost may be achieved.

### SUMMARY OF THE INVENTION

To achieve the objectives, a vehicle multifunctional lamp in the present invention mainly includes a lamp body, a lamp shade, and light source sets. More than two light source regions are partitioned inside the lamp body. The light source sets have at least two sets. At least one of the at least two light source sets is daylight lamps, and the rest is one or more of sidelights, fog lamps, and turn signal lamps. The light source sets are installed within different light source regions inside the lamp body, respectively. The light source sets are electrically connected to an electronic control system, respectively. Thus, a lamp formed of the same lamp body and the lamp shade is a car lamp having functions of a daylight lamp and other indicators.

For the vehicle multifunctional lamp stated above, external profile dimensions of the lamp body and the lamp shade may be designed and used in various shapes or sizes. The lamp body and the lamp shade are installed outside a car body in a manner of external hanging. The external profile dimensions of the lamp body and the lamp shade may otherwise be designed using specifications, dimensions, and shapes of the vehicle sidelights, the turn signal lamps or the fog lamps etc. originally equipped for a car. A position of the indicators equipped originally may be used for replacement by the vehicle multifunctional lamp.

When the structure is used, an indefinite-form external hanging type lamp may be selected to be installed at a position where a fog lamp or some other auxiliary lamp is externally hanged originally. Thus, a labor time for finding another poison for installment may be saved. Also, the structure may have effects of two or three lamps, avoiding that car lamps hang all over a car. In addition, if a vehicle multifunctional lamp having the same specifications with an originally equipped lamp, the vehicle multifunctional lamp may then be directly installed at an original lamp position. Thus, the present invention may conform to regulations of traffic laws in some countries, increase driving safety, and have effects of convenient installment, time saving, and labor saving.

### BRIEF DESCRIPTION OF THE DRAWINGS

The present invention will become more fully understood from the detailed description given herein below for illustration only, and thus are not limitative of the present invention, and wherein:

FIG. 1 is a three-dimensional exploded view of an embodiment of the present invention;

FIG. 2 is a three-dimensional assembly view of FIG. 1;

FIG. 3 is a three-dimensional assembly view of an embodiment of the present invention; and

FIG. 4 is a three-dimensional assembly view of FIG. 3.

### DETAILED DESCRIPTION OF THE INVENTION

To make the examiner further recognize and understand structures, devices and features thereof of the present invention, several preferred embodiments are illustrated in detail in connection with the drawings.

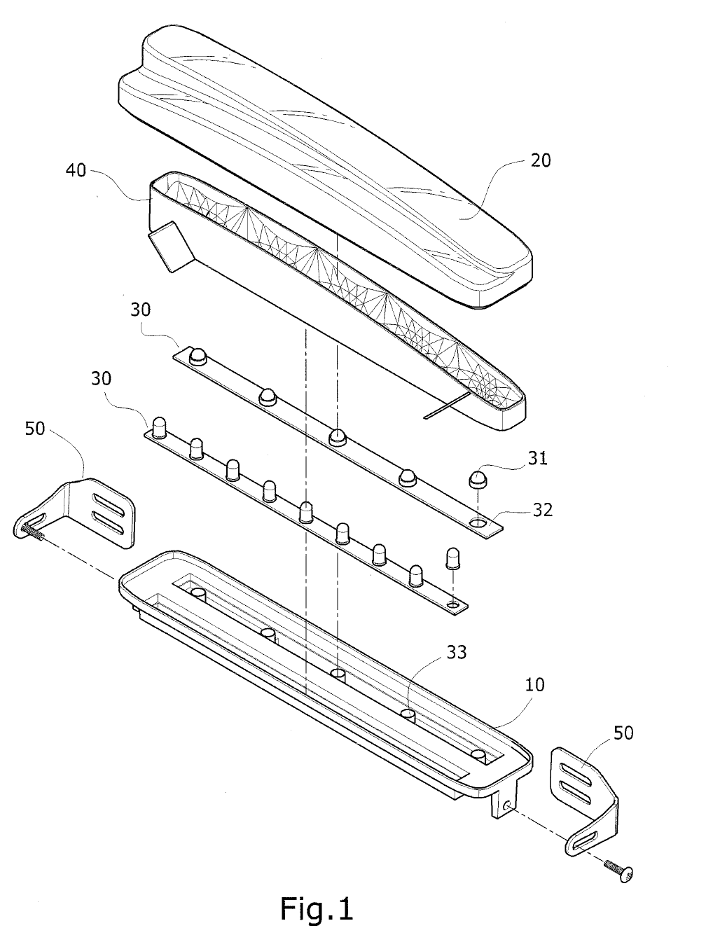

First, referring to FIGS. 1 to 4, a vehicle multifunctional lamp shown in the embodiment mainly includes a lamp body 10, a lamp shade 20, and light source sets 30. More than two light source regions are partitioned inside the lamp body 10. The light source sets 30 have at least two sets. At least one of the at least two light source sets 30 is daylight lamps, and the rest is one or more of sidelights, fog lamps, or turn signal lamps. The light source sets 30 are installed within different light source regions inside the lamp body 10 respectively, and are electrically connected to an electronic control system, respectively. Thus, a lamp formed of the same lamp body 10 and the lamp shade 20 is a car lamp having functions of the daylight lamp and other indicators.

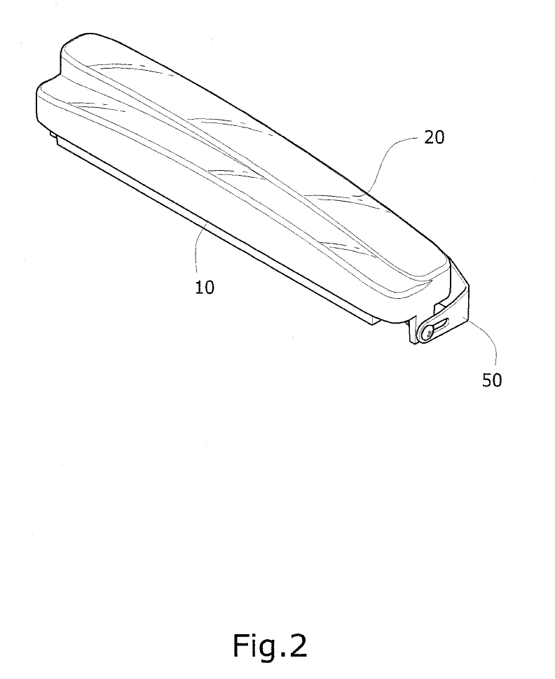

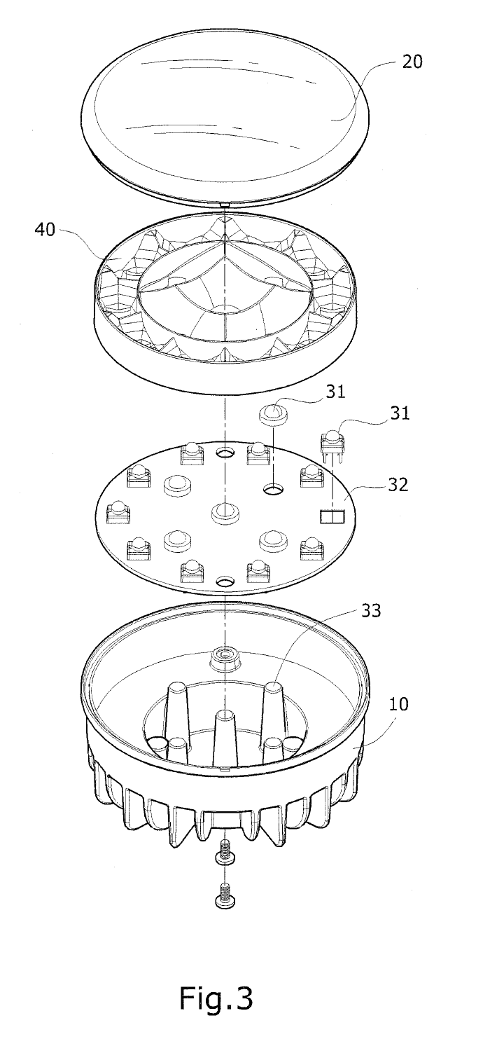

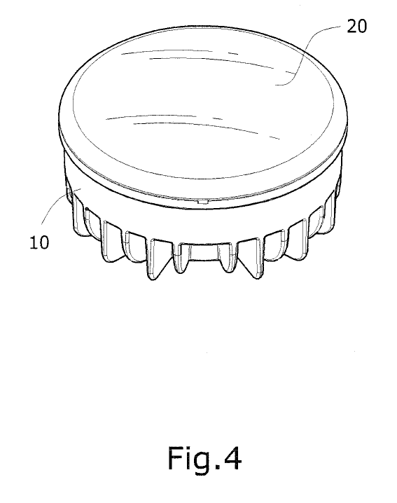

For the vehicle multifunctional lamp, external profile dimensions of the lamp body 10 and the lamp shade 20 may be designed and used in various shapes or sizes. The lamp body 10 and the lamp shade 20 are installed outside a car body in a manner of external hanging (as shown in FIGS. 1 and 2). The external profile dimensions of the lamp body 10 and the lamp shade 20 may follow specifications, dimensions, and shapes of the vehicle sidelights, the turn signal lamps or the fog lamps etc. originally equipped for a car. The position of the indicator lamp equipped originally may be used for replacement by the vehicle multifunctional lamp (as shown in FIGS. 3 and 4).

Still for the structure, the light source sets 30 in an embodiment of the present invention are formed by disposing a plurality of while-light or yellow-light light emitting diodes (LED) 31 on a circuit board 32 or lamp holders 33. Regions of projecting light of the light source sets 30 are separated by reflectors 40 in the lamp, such that the lamp may indeed achieve an effect of multifunction. In addition, as shown in the embodiment in FIGS. 1 and 2, two supports 50 are disposed at two sides of the lamp, respectively. Thus, when the lamp is installed, the lamp may be fixed on car frames of front and rear bumper arms or on grids of fan safety screens by the supports 50 (not shown), or at any positions in a specialized installing region.

When the structure is used, an indefinite-form external hanging type lamp may be selected to be installed at a position where a fog lamp or some other auxiliary lamp is hanged externally originally. Thus, a labor time for finding another position for installment is saved. Also, the structure has effects of two or three lamps, avoiding that car lamps hang all over a car. In addition, if a vehicle multifunctional lamp having the same specifications with a lamp equipped originally is selected, the lamp may then be installed at the original lamp position directly. The daylight lamp may even be switched to relatively low brightness by way of circuit control, such that the daylight lamp has a double function of a daylight lamp and a sidelight. Thus, the present invention may conform to regulations of traffic laws in some countries, increase driving safety, and have effects of convenient installment, time saving, and labor saving.

The vehicle multifunctional lamps in the disclosed embodiments are two of many feasible embodiments of the present invention, and therefore the claims of the present invention are not limited hereto. Equivalent changes that those skilled in the art may understand should all fall within the scope of the patent right of the present invention without departing from the spirit of the conception of the present invention.

In conclusion, the vehicle multifunctional lamp of the present invention may indeed achieve effects of multifunction, and convenient installment, labor time saving. Also, no same objects or technologies are publicly used before the application. Thus, the application conforms to elements of a utility model, and application of a utility model is filed here by law.

What is claimed is:

1. A vehicle multifunctional lamp, comprising a lamp body, a lamp shade, and light source sets, wherein:
more than two light source regions are partitioned in the lamp body;
the light source sets have at least two sets, at least one of the at least two light source sets is daylight lamps, the rest is one or more of sidelights, fog lamps, and turn signal lamps, the light source sets are installed within different light source regions inside the lamp body respectively, and the light source sets are electrically connected to an electronic control system respectively.

2. The vehicle multifunctional lamp according to claim 1, wherein external profile dimensions of the lamp body and the lamp shade are designed and used in various shapes or sizes, and the lamp body and the lamp shade are installed outside a car body in a manner of external hanging.

3. The vehicle multifunctional lamp according to claim 1, wherein external profile dimensions of the lamp body and the lamp shade follow specifications, dimensions, and shapes of the vehicle sidelights, the turn signal lamps or the fog lamps, etc. originally equipped for a car.

4. The vehicle multifunctional lamp according to claim 1, wherein the daylight lamp is reduced in brightness by circuit control to achieve a double function of a daylight lamp and a sidelight.
